(19) United States
(12) Patent Application Publication
(10) Pub. No.: US 2004/0226481 A1
(43) Pub. Date: Nov. 18, 2004

(54) Heat resistant paint

(76) Inventor: Leroy Gonzales, Olmito, TX (US)

Correspondence Address: Leroy Gonzales, P.O. Box 595, Olmito, TX, 78575, US

(21) Appl. No.: 10/430,444

(22) Filed: Apr. 29, 2003

(51) Int. Cl. C09D 4/00

(52) U.S. Cl. 106/483; 106/253

(57) ABSTRACT

Resistance to heat flow is known by the symbol R if the same heat is flowing through two substances, the total resistance is equal to the resistance of each substance.

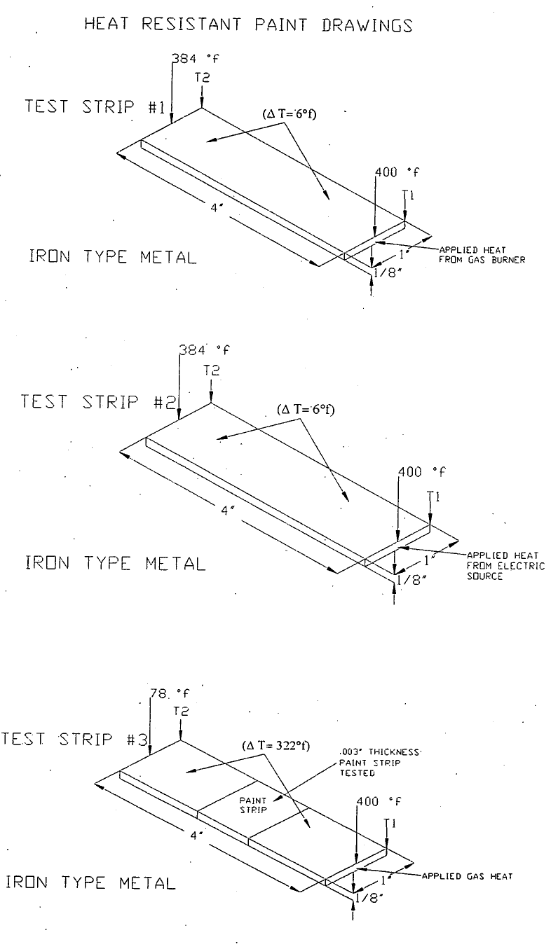

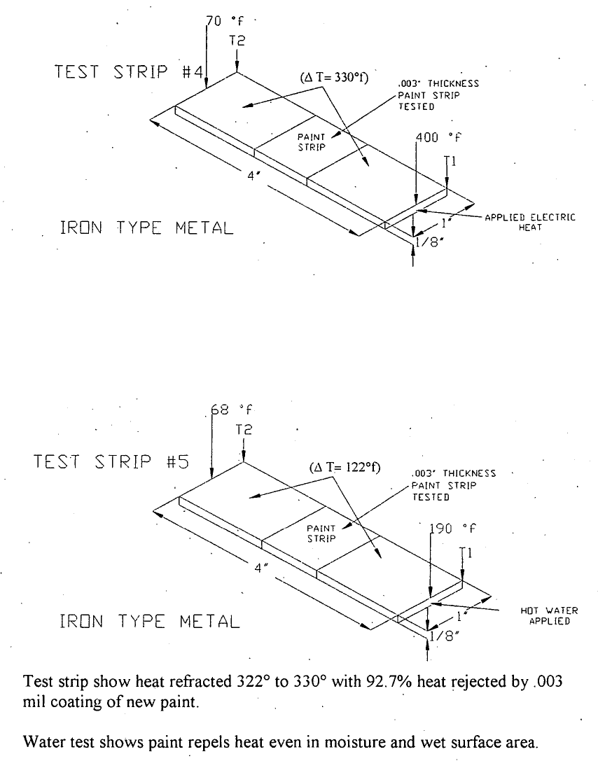

Rt=R1+R

Rt=Resistance total

R1=Resistance of substance 1

R2=Resistance of substance 2

R is the reciprocal (inverse) of K, or R=1/K in the formula, it would be 1/Kt=1/K1+1/K2

Kt=Conductance, total

K1=Conductance, substances

K2=Conductance, substance 2

If the wall is make up of three different materials,

| Ambient Temp | Heat Flow |
|---|---|
| 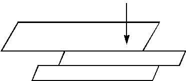 | 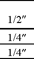 |

KT=0.333 which is the conductivity for the panel in BTU/ft²/hr/° f

Sample of Paint Applied to Test Paint

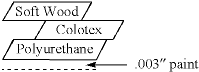

Paint consists of a pigment dispersed in a vehicle of binder. This adheres to the substrate and forms a solid film. A solvent is normally used to control the consistency. This fluid can be applied in thin layers, if necessary, to form a solid colored coating providing both decoration and protection.

The paint industry is constantly reviewing its paints and paint pigment products. NASA's requirement for high temperature pigment paint has motivated much of the advancements in this area. Dupont, INC. and Hooker Chemicals, INC have designed some of these applications. Many of these applications have not been identified with patents. Concerns also addressed in pigment designs are weather resistance and color quality.

Government standards have placed such stringent requirements on the manufacturing of paint pigments that the ability to meet them and produce a quality product is almost impossible. Paints are reviewed and tested for carcinogenic compounds and toxic metals. There are several paints that have forced paint companies to study the possibilities of wood, rocks, metals, asphalts, and concrete as a pigment in order to meet the various conditions to which the paint is exposed. Equipment cost required to develop and test these various products is extremely high, while the are of pigment selection and sizing is changing continually.

This is a paint pigment product. It is heat resistant up to 625 degrees F. The R factor for this material is 40 at 3 mil. Thickness, therefore, it produces an excellent insulating paint. The strong body of the electrolytic base material also prevents barnacles, pesticides, and funguses from attaching to the paint surface. This material has the electron pull necessary to attach to difficult surfaces. It is effective on units subject to high ratios of expansion and contraction such as precast concrete panels and expansion joints. It also will perform well in the masking of adjacent surfaces when necessary to protect the substrates. It accommodates both man made and natural products. This paint is based on a two component material selection. It is frequently used in waterproof coatings and road markers. It can be applied to metal and fiberglass. These two materials will bond to butyl sealant base (the same as used on metal curtains and wall construction), because of its ability to function in thin application. When movement is within the capacity of the base, then the selected materials will function properly in:

| | |
|---|---|
| 1. | Weathering resistance |
| 2. | Recovery % |
| 3. | Adhesion |
| 4. | Joint expected movement |
| 5. | Shrinkage % |
| 6. | Talk-free time (HR) |
| 7. | Water immersion |
| 8. | Paintable |
| 9. | Primer required |
| 10. | Ultimate elongation % |
| 11. | Horizontal joints |
| 12. | Modulus of elasticity lb./in sq. |
| 13. | No primers required |
| 14. | Good UV resistance |
| 15. | Minimal surface preparation |
| 16. | Fast cure stage |
| 17. | (2) Two added component |
| 18. | Horizontal application |
| 19. | Excellent recovery |
| 20. | High thermal stability |
| 21. | Non-abrasive. |

Mineral: Montlivaltia.

Solitary and large. cylindrical elongated, conical in shape with a circular cross section:

Septa: Long and very numerous, radiating from its elongated central pit on the upper edge Axial structures are weak and occasionally absent. Transverse grooves are usually absent.

Mineral: Peralkaline Granite.

Texture is similar to granite but rarely faliated.

Structure is similar to granite but xenoliths less common

Room Temp

Th₁=Thickness of material (1)

Th₂=Thickness of material (2)

Th₃=Thickness of material (3)

The formula becomes

$$K t = \frac{1}{\frac{{Th}_{1}}{{K}_{1}} + \frac{{Th}_{2}}{{K}_{2}} + \frac{{Th}_{3}}{{K}_{3}}}$$

K₁=Conductivity Factor 1

K₂=Conductivity Factor 2

K₃=Conductivity Factor 3

K_{T}=unit of conductivity for materials of a composite nature.

U+Unit of conductivity for a material of a composite nature plus the effect of the AR clinging to both the outside (FO) and the inside (FI) walls.

$$U = \frac{1}{1 / 6.0 + .5 / .80 + .25 / .31 + .25 / .16 + 1 / 1.65} \\ = \frac{1}{.166 + .625 + .807 + 1.563 + .606} \\ = \frac{1}{3.767} = .27 \; 13 TU \text{/} 2 ft \text{/} hr \text{/} {}^{∘} F . \\ KT = \frac{1}{.5 / .8 + .25 / .31 + .25 / .16} \\ = \frac{1}{.625 + .807 + 15.3}$$

1. The mineral selection of montivatia is a solitary and large, cylindrical. conical elongated in shape, with a circular cross-section. The septum is long and very numerous, radiating from all elongated central pits on the upper surface, with a serrated top edge. It has all axial stricture that is encapsulated with transverse grooves. This mineral is ground to a 34-micron size and dried to a −80 dew point.

2. The mineral selection of peralkaline granite is recognized with a texture similar to granite, but rarely faliated. Similar to granite. but xeonoliths less common, and it is a rock fragment foreign to the igneous mas in which it occurs (xenolithic). This mineral is ground to a 34-micron size and dried to a −80 dew point.

3. Mix equal amounts of finely ground (32 micron) minerals together: 50% monlivaltia powder +50% peralkaline powder of mineral.

4. Add the combined powder mix of minerals by weight, to an oil base of linseed oil of 50% of total mineral weight.

5. Process mixture (2 minerals+1 oil base) into a mix pulp for 1 hour at a mixing speed of 700 r.p.m. in a medium size 5 gallon mixer, driven by a Hobart gear drive with a 7 horsepower drive motor, and the bowl turning at one r.p.m.

6. The product (Pulp) is designed to reject the heated electrons that are in motion, with thicknesses applied on the surface of paint pigment as required to achieve all insulation R factor at 40. (See Math)

7. Allow paint pigment to dry for 24 hours, regardless of climatic conditions.

8. Paint Pigment will withstand shock, water, electric current, and repel any form of heat applied.

9. Paint pigment will reject all forms of light in UV and IR light spectrum for indefinite periods of exposure.
